(19) United States
(12) Patent Application Publication
(10) Pub. No.: US 2010/0304001 A1
(43) Pub. Date: Dec. 2, 2010

(54) SOUTHERN DRY RUB

(76) Inventors: Gerald Sampson, Beltsville, MD (US); Annie Sampson, Beltsville, MD (US)

Correspondence Address: LAW OFFICE OF JERRY D. HAYNES , P.A, P.O. Box 350392, Fort Lauderdale, FL, 33335, US

(21) Appl. No.: 12/476,323

(22) Filed: Jun. 2, 2009

(51) Int. Cl. A23L 1/223; A23L 1/221

(52) U.S. Cl. 426/650; 426/518

(57) ABSTRACT

The present invention relates to a seasoning mixture and a method of making the mixture, comprising: a combination of Peppercorn Melanges, Cracked Black Pepper, Crushed Red Pepper, Dried Garlic Flakes, Unseasoned Meat Tenderizer, Sweet Paprika, Kosher Salt, Chinese Five Spice, Whole Cardamom, Brown Sugar, Ground Cumin, Dry Onion Flakes, Star Anise, Pickling Spice, Dry Rub Sage, Coriander Seeds, Ground Cloves, Dry Thyme, Nutmeg and Cinnamon. The seasoning mixture according the present invention is finely ground to create a dry rub.

### BACKGROUND OF THE INVENTION

1. Field of Invention

The present invention relates to a dry rub seasoning mix to utilize as a means for flavoring food.

2. Description of Related Art

Spices and seasoning rubs provide a means to season foods prior to cooking. A spice rub includes a mixture of ground spices where the mixture may be designed to elicit the taste buds of the consumer. As the rub is applied to food it may form a coating thereon to integrate the spices within the food and therefore heighten the taste thereof. Food may be allowed to marinate after applying rub or cooked immediately thereafter. Spice rub may be applied dry or added to oil in order to make a paste-like coating. Applying rubs to meats is especially popular with respect to barbecuing and grilling. Rubs may also be applied to foods prior to sauteing the food within a skillet.

Many chef and restaurants are known for their special seasoning rubs. Some common types of rubs include Cajun-seasoning rub, mesquite barbecue rub, mustard flavored, garlic, and tenderizing rubs. Many seasoning rubs may be given a name to reflect the seasoning style of the certain regions such as Carolina BBQ, Kansas City style, New Orleans style, or Jamaican jerk seasoning to name a few. Still further other rubs may be created for specific types of foods such as steaks, seafood, pork, ribs or vegetables. Regardless of the application seasoning rubs are a common means to flavor food especially meats prior to cooking.

### SUMMARY OF THE INVENTION

The present invention relates to a seasoning mixture comprising: a combination of Peppercorn Melanges, Cracked Black Pepper, Crushed Red Pepper, Dried Garlic Flakes, Unseasoned Meat Tenderizer, Sweet Paprika, Kosher Salt, Chinese Five Spice, Whole Cardamom, Brown Sugar, Ground Cumin, Dry Onion Flakes, Star Anise, Pickling Spice, Dry Rub Sage, Coriander Seeds, Ground Cloves, Dry Thyme, Nutmeg and Cinnamon. The seasoning mixture according the present invention is finely ground to create a dry rub.

The present invention also relates to a method of making a seasoning mixture comprising the steps of: grinding Coriander Seeds, Pickling Spice, Star Anise, Whole Cardamom, Dry Onion Flakes, Dried Garlic Flakes and Brown Sugar to a fine consistency, where said grinding creates a first mixture; adding Peppercorn Melanges, Cracked Black Pepper, Crushed Red Pepper, Unseasoned Meat Tenderizer, Sweet Paprika, Kosher Salt, Chinese Five Spice, Ground Cumin, Dry Rub Sage, Ground Cloves, Dry Thyme, Nutmeg, and Cinnamon to the first mixture; and grinding the combined mixture to a fine consistency, where said grinding creates a seasoning mixture.

### DETAILED DESCRIPTION

The present invention relates to a southern style dry rub which provides a seasoning mix that may be used as a spice rub prior to cooking or as a marinate after being applied to a food. The dry rub according to the present invention uses a unique mixture of seasoning that is ground to a fine texture and applied to any type of food but may be especially Favorable on beef, pork and poultry.

The dry rub according to the present invention includes 20 separate seasoning spices that are combined and then applied to food as desired. The following provides a listing of the spices used in the dry rub according to the present invention.
1. Peppercorn Melanges
2. Cracked Black Pepper
3. Crushed Red Pepper
4. Dried Garlic Flakes
5. Unseasoned Meat Tenderizer
6. Sweet Paprika
7. Kosher Salt
8. Chinese Five Spice
9. Whole Cardamom
10. Brown Sugar
11. Ground Cumin
12. Dry Onion Flakes
13. Star Anise
14. Pickling Spice
15. Dry Rub Sage
16. Coriander Seeds
17. Ground Cloves
18. Dry Thyme
19. Nutmeg
20. Cinnamon

The dry rub mixture according to the present invention combines the above-listed ingredients into a finely ground spice that may be applied to the food as desired. The initial ingredients are first ground to a fine composition where the initial ingredients comprise Coriander Seeds, Pickling Spice, Star Anise, Whole Cardamom, Dry Onion Flakes, Dried Garlic Flakes and Brown Sugar. After this combination is ground to a fine consistency, then the remaining ingredients are added to the mixture and once these additional ingredients are added, the composition may be ground to a fine consistency.

In one exemplary environment the above-listed ingredients may be combined in the following amounts in order to prepare a batch of the southern dry rub according to the present invention.

| MEASUREMENT | INGREDIENT |
|---|---|
| ½ Cup | Peppercorn Melanges |
| ½ Cup | Cracked Black Pepper |
| ½ Cup | Crushed Red Pepper |
| 1 Pound | Dried Garlic Flakes |
| 1 Pound and 2 Ounces | Meat Tenderizer Unseasoned |
| 1 Gallon | Sweet Paprika |
| 2 to 3 Pounds | Kosher Salt |
| 2 Gallons | Chinese Five Spice |
| ¼ Cup | Whole Cardamom |
| 6 Pounds and 12 Ounces | Brown Sugar |
| 3 Pounds and 6 Ounces | Ground Cumin |
| 1 Pound | Dry Onion Flakes |
| ½ Cup | Star Anise |
| 3 Pounds and 6 Ounces | Pickling Spice |
| 1 Pound and 2 Ounces | Dry Rub Sage |
| ½ Pound | Coriander Seeds |
| ½ Cup | Ground Cloves |
| 1 Pound | Dry Thyme |
| ½ Cup | Nutmeg |
| 1 Cup | Cinnamon |

As stated above, an initial mix of a portion of the above-listed ingredients includes Coriander Seeds, Pickling Spice, Star Anise, Whole Cardamom, Dry Onion Flakes, Dried Garlic Flakes and Brown Sugar are initially ground to a fine consistency. These ingredients are then mixed with the remaining ingredients in the above listed amounts and then reground to a fine consistency in order to make a superb southern dry rub according to the present invention.

Once this batch of dry rub is complete it may be packaged in various sizes to accommodate retail sales or larger packaging for sales to restaurants for volume use. The dry rub seasoning according to present invention may also be used as a dry rub or marinade paste where the mixture of spices can be used on items such as acorn, squash, cabbage, greens or other types of beans. The dry rub according to the present invention provides a delicious seasoning mix and an excellent compliment to any food or meat.

What is claimed is:

1. A seasoning mixture comprising:
a. a combination of Peppercorn Melanges, Cracked Black Pepper, Crushed Red PepperDried Garlic Flakes, Unseasoned Meat Tenderizer, Sweet Paprika, Kosher Salt, Chinese Five Spice, Whole Cardamom, Brown Sugar, Ground Cumin, Dry Onion Flakes, Star Anise, Pickling Spice, Dry Rub Sage, Coriander Seeds, Ground Cloves, Dry Thyme, Nutmeg, and Cinnamon.

2. The seasoning mixture according to claim 1, where the mixture of seasoning is finely ground.

3. The seasoning mixture according to claim 1, where the mixture of seasoning creates a dry rub.

4. A method of making a seasoning mixture comprising the steps of:
a. grinding Coriander Seeds, Pickling Spice, Star Anise, Whole Cardamom, Dry Onion Flakes, Dried Garlic Flakes and Brown Sugar to a fine consistency, where said grinding creates a first mixture;
b. adding Peppercorn Melanges, Cracked Black Pepper, Crushed Red Pepper, Unseasoned Meat Tenderizer, Sweet Paprika, Kosher Salt, Chinese Five Spice, Ground Cumin, Dry Rub Sage, Ground Cloves, Dry Thyme, Nutmeg, and Cinnamon to the first mixture; and
c. grinding the combined mixture to a fine consistency, where said grinding creates a seasoning mixture.

5. The method of making a seasoning mixture where said seasoning mixture is a dry rub.
